(19) United States
(12) Patent Application Publication
(10) Pub. No.: US 2022/0137082 A1
(43) Pub. Date: May 5, 2022

(54) METHOD FOR DETERMINING A SPEED OF AN ELECTRONICALLY COMMUTATED ELECTRIC MOTOR

(71) Applicant: AUDI AG, Ingolstadt (DE)

(72) Inventor: Karsten BARTH, Chemnitz (DE)

(73) Assignee: AUDI AG, Ingolstadt (DE)

(21) Appl. No.: 17/430,845

(22) PCT Filed: Mar. 20, 2020
(86) PCT No.: PCT/EP2020/057730

§ 371 Date: Aug. 13, 2021

(30) Foreign Application Priority Data
Apr. 12, 2019 (DE) 10 2019 205 312.2

(51) Int. Cl. G01P 3/44; H02P 6/14; H02P 6/28

(52) U.S. Cl. CPC G01P 3/44; H02P 6/28; H02P 6/14

(57) ABSTRACT

A method for determining a speed of an electronically commutated electric motor, in particular an electric motor of a fan. The current measured values are acquired at multiple points in time, which describe an amperage of a drive current supplied to the electric motor, after which a speed of the electric motor is determined as a function of the acquired current measured values.

In particular in motor vehicles, the robust cooling of specific components using fans is potentially highly relevant for operation of the corresponding components. For example, if two vehicle electrical networks using different voltages, for example, a 12 V network and a 48 V network, are connected via a DC/DC converter, it is typically necessary at least in some operating situations to cool them. It is preferably to be recognized robustly here whether the fan is functional.

One simple diagnosis option is to check whether the fan consumes power during operation. In this way, for example, it can be recognized whether the fan is correctly installed. However, if a comprehensive onboard diagnosis is to be possible, this may not be sufficient. For example, a blocked fan can consume power and nonetheless not have a cooling effect.

To carry out speed monitoring of a fan, providing a tachometer signal via a corresponding sensor installed in the fan and an additional line is known. Since an additional line is required, the fan can no longer be connected in a typical manner or has to be connected to a communication interface in addition to the normal wiring. This significantly increases the production expenditure for the vehicle.

The document DE 198 07 253 C1 discloses a circuit arrangement for speed detection of electronically commutated fans. In this case, current slopes of current fluctuations caused by the fan on its power supply lines are evaluated.

The document U.S. 7,304,470 B2 proposes carrying out an analog differentiation and filtering of voltages, which drop at a shunt resistor connected in series to a fan. The resulting signal is converted into a digital pulse signal and supplied to a frequency counter module to ascertain a rotational velocity of the fan.

The differentiation and pulse forming described in the prior art of voltages dropping at shunt resistors results in a relatively large circuit expenditure, on the one hand. On the other hand, a strong sensitivity of the measurement to high-frequency interference signals results from the flank detection or the evaluation of differentiated signals. These can occur in particular if a DC/DC converter having high switching frequency is used to supply the fan.

The invention is therefore based on the object of providing an option improved in relation thereto for determining a speed of an electronically commutated electric motor, which is in particular less sensitive to high-frequency interferences and therefore in particular enables robust speed detection even if the electric motor is supplied via a DC/DC converter switching at high frequency.

The object is achieved according to the invention by a method of the type mentioned at the outset, wherein current measured values are acquired at multiple points in time, which describe an amperage of a drive current supplied to the motor, according to which a speed of the motor is determined as a function of the acquired current measured values.

It is therefore proposed that the time derivative of an amperage or a measured variable describing the amperage not be evaluated, but rather the amperage or corresponding current measured values be acquired directly. The acquisition of a time derivative of an amperage or a corresponding current measured value would not be suitable for describing the amperage of a drive current supplied to the motor, since it cannot correctly describe a direct current component. Since the current measured values directly describe the amperage and not a time derivative of the amperage, the above-described amplification of high-frequency frequency components and thus in particular of interference signals, which can be caused, for example, by DC/DC converters switching at high frequency, is avoided. At the same time, a particularly simple circuit structure can be achieved by the acquisition of current measured values which directly describe the amperage of the motor, as will be explained in more detail hereinafter. The acquisition of the current measured values can in particular take place at relatively high sampling rates, thus, for example, at least five times or at least ten times the rate of the frequency of the electronic commutation of the electric motor. Current measured values can be acquired, for example, at a resolution of eight bits or sixteen bits.

The method according to the invention can be carried out in particular in the scope of a diagnostic method, to diagnose an electric motor or a fan. In particular, the diagnostic method can be used to recognize a blockage of the motor or fan. For example, it can be recognized that the speed remains for a long time at zero or a very low value, in particular below a limiting value, upon energizing, and in this case a corresponding interference message can be transmitted to a diagnostic device or the like.

The speed of the electric motor can be determined as a function of which of the acquired current measured values reaches or falls below a predetermined limiting value. With electronic computation of an electric motor, all phases are typically separated in the short term. With a sufficiently high bandwidth of the acquisition, thus in particular with a sufficiently high-frequency analog-to-digital conversion and a use of sufficiently broad filters in the acquisition path, the point in time could therefore be recognized in principle at which current does not flow and therefore the point in time of the commutation can also be recognized unambiguously. Since typically the achievable bandwidth and converter rate are limited and/or the signal is noisy, typically a current measured value which corresponds to the current flow of zero is not measured even during switching of the commutation of the electric motor. Therefore, a limiting value somewhat above the current measured value which corresponds to a current flow of zero is preferably selected, so that all commutations of the electric motor can actually be recognized. For example, the limiting value can be selected so that the current measured value falls below it if the amperage of the drive current drops below 10%, below 30%, below 50%, or below 70% of an average amperage.

The speed of the electric motor can be determined as a function of the points in time at which and/or the time interval at which current measured values are acquired, which reach or fall below the or a predetermined limiting value. For example, a counter can be read out and reset each time the value falls below the limiting value in order to acquire a time interval of corresponding current measured values. The counter value is proportional in this case to the period of a commutation of the electric motor, thus inversely proportional to the commutation frequency and thus also to the speed of the electric motor. To obtain a less noisy speed signal, for example, averaging, a media selection, or the like can be carried out for the measured time intervals or the determined frequencies.

The drive current can be provided by a driver circuit, in particular a DC/DC converter, wherein the driver circuit provides an output for a measurement voltage proportional to the drive current, wherein the voltage values of this measurement voltage are acquired as current measured values. The driver circuit can be switchable in particular to activate or deactivate the electric motor as needed. For example, it can be a DC/DC converter, thus a DC voltage converter, or can be part thereof to provide a defined or variable operating voltage for the electric motor.

The simplest way of providing a measurement voltage proportional to the drive current is to use a shunt resistor within the driver circuit, via which the drive current is guided. Since this can result in additional power losses, it can be advantageous to use a separate measurement path instead. For example, connecting an RC element, thus a series circuit of resistor and capacitor, in parallel to a coil used in the context of the DC/DC conversion, is known in DC/DC converters. By appropriate matching of the RC element to the impedance of the coil, a voltage can drop at the capacitor which is proportional to the current provided by the DC/DC converter. A corresponding procedure is known in principle in the prior art and will therefore not be explained in detail. Filtering is effectively implemented by corresponding selection of the resistor and the capacitor of the RC element. In this case, the selection in the driver circuit used in the method according to the invention can take place in such a way that the switching frequencies used in the DC/DC converter are filtered, but the typically significantly lower frequencies at which the electric motor is commutated and therefore the current fluctuates due to the commutation of the electric motor can be acquired essentially undamped.

The current measured values can be acquired by an analog-to-digital converter. In this case, the voltage values can be acquired directly or after low-pass filtering, wherein a relatively broadband acquisition is desired. For example, the limiting frequency of the acquisition can be multiple tens of kilohertz or multiple hundreds of kilohertz. The sampling rate of the analog-to-digital converter is to be selected to be at least twice as high as the limiting frequency. A filtering before the conversion can be carried out, for example, by an antialiasing filter of the converter integrated in any case into many analog-to-digital converters. In particular, the limiting frequency is selected so that it is greater, in particular greater by at least the factor of five, ten, or twenty, than the maximum expected commutation frequency of the electric motor.

The electric motor can drive a fan which cools a component which is a DC/DC converter or a rectifier or an inverter and/or which is or comprises a processing unit, which is configured to ascertain the speed or an item of information depending on the speed. As explained at the outset, in the case of DC/DC converters, rectifiers, or inverters, in particular in motor vehicles or other devices in which relatively large currents are converted, it is frequently necessary to cool them, wherein disturbances to this cooling are to be recognized robustly. The speed recognition according to the invention can be used for this purpose as explained. DC/DC converters, rectifiers, or inverters frequently comprise a processing unit in any case, for example a microcontroller, for example, to control or regulate provided voltages and/or currents. Since monitoring of the emitted amperage is frequently possible in any case here, the method according to the invention can already be implemented by a minor adaptation of the programming of the corresponding processing unit and optionally by a replacement of a filter, which is implemented IC-externally, for example, for the current acquisition. The processing unit can, for example, process the acquired speed exclusively internally, for example, compare it to a limiting value and if it falls below the limiting value or it falls below the limiting value for a predetermined time interval, can transmit a corresponding notification signal to an external unit, for example, a control unit of the device or the motor vehicle. In this way, the external unit can be informed immediately about a disturbance of the operation of the fan, in particular about a blockage of the fan.

In addition to the method according to the invention, the invention relates to a device, in particular a motor vehicle, comprising an electronically commutated electric motor, in particular an electric motor of a fan, and a processing unit, wherein the processing unit is configured to ascertain the speed of the electric motor according to the method according to the invention. The features and details explained for the method can be transferred with the advantages mentioned thereto the device according to the invention and vice versa.

The electric motor can drive a fan, wherein the device comprises at least one component cooled by the fan, which is a DC/DC converter or a rectifier or an inverter and/or which comprises the processing unit. This was already explained above. In particular in motor vehicles, large amounts of energy are often converted by the mentioned components, whereby robust cooling is required and disturbances of this cooling are to be recognized robustly. For example, a DC/DC converter in a motor vehicle can connect a low-voltage vehicle electrical network to a high-voltage vehicle electrical network. For example, a 12 V vehicle electrical network and a 48 V vehicle electrical network can be provided in the motor vehicle, in each of which parts of the electronic components are present. To connect these two vehicle electrical networks to one another and, for example, enable charging of a battery in one of the vehicle electrical networks using energy from the other of the vehicle electrical networks or the like, a DC/DC converter can be provided, which can be cooled as explained by a fan. A failure of a fan is to be recognized robustly since overheating of such a DC/DC converter can easily result in malfunctions or damage in the vehicle. The explained speed monitoring is therefore particularly advantageous in this case.

The processing unit can be configured to provide an item of diagnostic information to a diagnostic unit of the device or a device-external diagnostic unit, which relates to the functionality of the or a fan driven by the electric motor and is dependent on the determined speed. For example, the diagnostic information can be dependent on whether the speed exceeds a predetermined speed limiting value upon energizing of the electric motor or whether the speed falls below such a limiting value for a time interval which exceeds a time limiting value. It can thus be recognized whether the fan is blocked. If this is the case, a warning message can be output to a user of the device by the diagnostic unit, for example, an emergency operation of the device can be used, in which, for example, a DC/DC converter, rectifier, or inverter is no longer used or is used with changed parameterization, or the like. In this way, for example, overheating of corresponding components can be avoided.

The following exemplary embodiments and the associated drawings show further advantages and details of the invention. In the schematic figures:

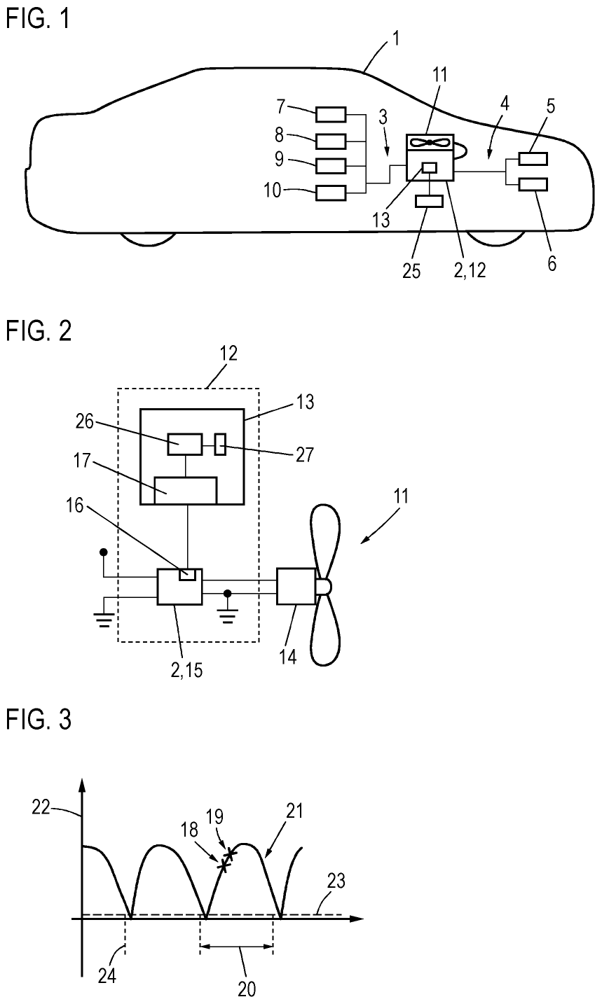

FIG. 1 shows an exemplary embodiment of a device according to the invention, namely a motor vehicle, which is configured, for example, to carry out an exemplary embodiment of the method according to the invention,

FIG. 2 shows a detail view of the device shown in FIG. 1, and

FIG. 3 shows the time curve of current measured values acquired in the scope of the exemplary embodiment of the method according to the invention.

FIG. 1 shows a device 1, in the specific example a motor vehicle, which comprises a DC/DC converter 2, to connect two vehicle networks 3, 4 using different DC voltages to one another. For example, the vehicle network 4 can be a 48 V network or a high-voltage network, which comprises a battery 5 and a starter generator 6 in the example shown. The vehicle network 3 can be a low-voltage network, for example a 12 V network, which comprises a further battery 7 and further low-voltage components, for example a lighting system 8, driver assistance systems 9, and a multimedia system 10. Due to the connection of the vehicle networks 3, 4 via the DC/DC converter 2, energy can be transported between these vehicle networks 3, 4, for example, to charge the battery 7 via the starter generator 6 or to start the motor vehicle using energy of the battery 7, to exchange energy between the batteries 5, 7, or the like.

Although DC/DC converters have gradually achieved very high efficiencies, it is typically necessary to actively cool corresponding components 12, thus the DC/DC converter 2. For this purpose, the motor vehicle comprises a fan 11, which is also powered by the DC/DC converter 2.

A failure or a blockage of the fan 11 is to be recognized, for example, to avoid overheating in this case by a corresponding adaptation of the operation of the DC/DC converter 2 or by a temporary prevention of the energy exchange between the vehicle networks 3, 4. For this purpose, a processing unit 13, which monitors the speed of an electric motor (not shown in FIG. 1) of the fan 11, is integrated into the component 12 to be cooled. The method used for this purpose and further components relevant in this regard are explained in more detail hereinafter with reference to FIGS. 2 and 3.

As schematically shown in FIG. 2, the electric motor 14 of the fan 11 is supplied via the DC/DC converter 2, which is thus used as a driver circuit 15 for the electric motor 14. It is known that corresponding DC/DC converters 2 or driver circuits 15 can have outputs 16, which provide a voltage which is proportional to a current provided by the DC/DC converter 2 or the driver circuits 15. This can be achieved, for example, by a shunt resistor connected in series, over which a corresponding voltage drops. However, an RC element is preferably connected in parallel to an active coil of the DC/DC converter 2, at the capacitor of which a corresponding voltage drops. This procedure is known in principle in the prior art and will therefore not be explained in more detail. Such an RC element can be integrated into the driver circuit 15 or formed separately from it. By corresponding selection of the resistance or capacitance value, the high-frequency switching frequencies of the DC/DC converter 2 can be filtered, wherein at the same time changes of the current due to the electronic commutation of the electric motor 14, during which the current flow to the motor is briefly interrupted in each case, can be recognized.

The voltages are supplied to an analog to digital converter 17 to acquire digital current measured values. As shown in FIG. 3, the sampling rate of the analog-to-digital converter 17 is selected so that the time interval between the acquisition of two successive current measured values 18, 19 is significantly less than the time interval of two expected commutations of the electric motor 14 of the fan 11. In this way, the time curve 21 of the current measured values 18, 19 can be acquired with sufficient time resolution that it is recognized that the current 22 drops essentially to zero at the points in time at which a commutation takes place.

To evaluate the time curve 21 of the current measured values 18, 19 and determine a speed or commutation frequency of the electric motor, the current measured values 18, 19 are compared to a limiting value 23 to recognize which of the current measured values 18, 19 are below the limiting value 23 or at which points in time 24 the current 22 falls below the limiting value 23. The time interval 20 between two such points in time 24 can be determined, for example, in that an internal counter of the processing unit 13 is read out and reset each time the measured values fall below the limiting value 23. Therefore, the time interval 20 between two times the measured values fall below the limiting value 23 and thus the time interval between two commutations of the electric motor can be determined. Since it is known how many commutations of the electric motor take place during each revolution of the electric motor, the speed of the electric motor can be calculated easily from the reciprocal of this time interval 20.

The described determination of the speed can be implemented, for example, by a processor 26 of the processing unit 13, which executes a corresponding program stored in a memory 27.

As explained at the outset, the described speed acquisition is primarily to be used to recognize whether the fan 11 is blocked. The processing unit 13 is therefore configured in particular to recognize whether a determined speed falls below a predetermined limiting value or remains below this limiting value for a predetermined time interval. An item of information in this regard can be provided to a separate diagnostic unit 25 to enable an onboard diagnosis in the device 1, thus in the motor vehicle. This can be used exclusively to output corresponding notifications, for example, to a user of the motor vehicle, to write corresponding items of information in an error memory, or the like. However, it is also possible to adapt the operation of the DC/DC converter 2 as a function of this diagnostic information, for example, to restrict or completely block an energy transfer between the vehicle networks 3, 4 if it is recognized that the fan 11 is blocked or excessively low speeds are acquired for other reasons.

1-9. (canceled)

10. A method for determining a speed of an electronically commutated electric motor, in particular an electric motor of a fan,
wherein current measured values are acquired at multiple points in time, which describe an amperage of a drive current supplied to the electric motor, after which a speed of the electric motor is determined as a function of the acquired current measured values.

11. The method as claimed in claim 10, wherein the speed of the electric motor is determined as a function of which of the acquired current measured values reach or fall below a predetermined limiting value.

12. The method as claimed in claim 10, wherein the speed of the electric motor is determined as a function of the points in time at which and/or the time interval at which current measured values are acquired, which reach or fall below the or a predetermined limiting value.

13. The method as claimed in claim 10, wherein the drive current is provided by a driver circuit, wherein the driver circuit provides an output for a measurement voltage proportional to the drive current, wherein voltage values of this measurement voltage are acquired as current measured values.

14. The method as claimed in claim 10, wherein the current measured values are acquired by an analog-to-digital converter.

15. The method as claimed in claim 10, wherein the electric motor drives a fan, which cools a component, which is a DC/DC converter or a rectifier or an inverter and/or which is or comprises a processing unit, which is configured to determine the speed or an item of information dependent on the speed.

16. A device, in particular a motor vehicle, comprising an electronically commutated electric motor, in particular an electric motor of a fan, and a processing unit, wherein the processing unit is configured to determine the speed of the electric motor wherein a speed of the electronically commutated electric motor is determined by current measured values acquired at multiple points in time, which describe an amperage of a drive current supplied to the electric motor, after which a speed of the electric motor is determined as a function of the acquired current measured values.

17. The device as claimed in claim 16, wherein the electric motor drives the fan, wherein the device comprises at least one component cooled by the fan, which is a DC/DC converter or a rectifier or an inverter and/or which comprises the processing unit.

18. The device as claimed in claim 16, wherein the processing unit is configured to provide an item of diagnostic information to a diagnostic unit of the device or a device-external diagnostic unit, which relates to the functionality of the or a fan driven by the electric motor and which is dependent on the determined speed.

19. The method as claimed in claim 11, wherein the speed of the electric motor is further determined as a function of the points in time at which and/or the time interval at which current measured values are acquired, which reach or fall below the or a predetermined limiting value.

20. The method as claimed in claim 11, wherein the drive current is provided by a driver circuit, wherein the driver circuit provides an output for a measurement voltage proportional to the drive current, wherein voltage values of this measurement voltage are acquired as current measured values.

21. The method as claimed in claim 12, wherein the drive current is provided by a driver circuit, wherein the driver circuit provides an output for a measurement voltage proportional to the drive current, wherein voltage values of this measurement voltage are acquired as current measured values.

22. The method as claimed in claim 11, wherein the current measured values are acquired by an analog-to-digital converter.

23. The method as claimed in claim 12, wherein the current measured values are acquired by an analog-to-digital converter.

24. The method as claimed in claim 13, wherein the current measured values are acquired by an analog-to-digital converter.

25. The method as claimed in claim 11, wherein the electric motor drives a fan, which cools a component, which is a DC/DC converter or a rectifier or an inverter and/or which is or comprises a processing unit, which is configured to determine the speed or an item of information dependent on the speed.

26. The method as claimed in claim 12, wherein the electric motor drives a fan, which cools a component, which is a DC/DC converter or a rectifier or an inverter and/or which is or comprises a processing unit, which is configured to determine the speed or an item of information dependent on the speed.

27. The method as claimed in claim 13, wherein the electric motor drives a fan, which cools a component, which is a DC/DC converter or a rectifier or an inverter and/or which is or comprises a processing unit, which is configured to determine the speed or an item of information dependent on the speed.

28. The method as claimed in claim 14, wherein the electric motor drives a fan, which cools a component, which is a DC/DC converter or a rectifier or an inverter and/or which is or comprises a processing unit, which is configured to determine the speed or an item of information dependent on the speed.

29. The device as claimed in claim 17, wherein the processing unit is configured to provide an item of diagnostic information to a diagnostic unit of the device or a device-external diagnostic unit, which relates to the functionality of the or a fan driven by the electric motor and which is dependent on the determined speed.
